(19) United States
(12) Patent Application Publication
(10) Pub. No.: US 2010/0107524 A1
(43) Pub. Date: May 6, 2010

(54) SEALING SPLINE CONNECTOR

(75) Inventor: Brent Moss, Gig Harbor, WA (US)

Correspondence Address: GEORGE A LEONE, SR;CITADEL PATENT LAW, 9124 Gravelly Lake Drive SW, SUITE 102, Lakewood, WA, 98499, US

(73) Assignee: Codel Entry Systems, Corp, Tacoma, WA (US)

(21) Appl. No.: 12/266,085

(22) Filed: Nov. 6, 2008

(51) Int. Cl. E06B 1/04

(52) U.S. Cl. 52/204.1; 52/745.15

(57) ABSTRACT

A door frame system including a spline. Each door frame section includes a brickmould and a jamb each having a groove on at least one side and the door frame sections are joined together by the spline. The spline includes a polymeric material having a shape such so as to form a moisture-resistant seal along the length of the joint. The spline is concealed from view when the brickmould and a jamb are connected together to form a frame including a uniform reveal.

### FIELD OF THE INVENTION

The present invention relates generally to a method and apparatus for connecting and sealing joints between door frame members, and, more particularly to a uniformly solid polymeric spline for joining at least two door frame members together to seal against air and moisture leaks along a joint between the door frame members.

### BACKGROUND OF THE INVENTION

Exterior door frames and the like are often assembled in a manufacturing facility and shipped as an assembly for quick installation into a house or similar structure. Exterior doors are typically assembled into a frame including brickmould and jamb members. Sealing the joint between the brickmould and jamb members is required to prevent air and moisture leaks around the door.

It is well-known that moisture penetration causes many adverse effects on building materials and may contribute to harmful health conditions such as promoting the growth of mold. For example, when mold spores are present in large quantities, they can present a health hazard to humans, potentially causing allergic reactions and respiratory problems.

The prevailing method for sealing exterior door frames is to caulk around the joints. However, due to aesthetic considerations, caulking is often only done on joints that are not visible after door installation. Caulking is a manual operation and its effectiveness is determined by the level of skill of the applier and the quality of the caulk employed. If the exterior, visible portion of the joint between the brickmould and the jamb is not properly sealed, the door remains exposed to both air and moisture leaks penetrating the frame. Further, as caulk ages, it is more likely to break down, thereby becoming less effective in sealing against leaks.

Another feature of many exterior doors is an attractive reveal surface, often simply called a reveal, between the brickmould and the jamb. For aesthetic purposes the reveal should present a uniform appearance around the entire door frame. It would be advantageous for a door frame fastening method to assure a uniform reveal around an entire door frame, while also providing a seal for the frame.

In the past, splines have been generally used in the construction industry to fasten side walls and the like in order to avoid the necessity of covering over nail holes or other exposed fasteners. See, for example U.S. Pat. No. 3,760,547 to Brenneman, issued Sep. 25, 1973. However, use of a solid spline for joining and sealing door frames in a uniform manner, allowing for a uniform reveal, where the joint has acceptable holding power while featuring ease of installation has not been addressed until the present invention.

### SUMMARY

A door frame system including at least one spline elongated in a direction of elongation, wherein the frame includes a plurality of door frame members. Each door frame member includes a brickmould and a jamb each having a groove on at least one side thereof. The door frame members are joined together by the at least one spline. The spline includes a polymeric material having a shape such that the spline has a sufficient width to fit into and extend outside of a groove in the side edge of the first door frame member and to fit into a respective groove in a side edge of the second door frame member, wherein the spline includes a top surface and a bottom surface, and wherein the spline has length matching the length of the first door frame member and the second door frame member so as to form a moisture-resistant seal along the length of the joint. The door frame system features the at least one spline concealed from view when the first door frame member and the second door frame member are connected together by the spline.

### BRIEF DESCRIPTION OF THE DRAWINGS

FIG. 1 schematically shows an example of a spline.

FIG. 2 shows a cross section view of an edge view of an example of two door frame members joined by a spline including a reveal surface.

FIG. 3 shows a partially cut away plan view of an example of two door frame members joined by a spline including a reveal.

FIG. 4 shows an exploded view of an example of a door system wherein a plurality of door frame members are assembled to provide a door frame having a uniform reveal.

FIG. 5 shows a front view of an example of a door system including a reveal.

FIG. 6 shows an illustrative example of a method to connect at least two door frame members together.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments and systems for imaging an object of interest. Several features of methods and systems in accordance with example embodiments of the invention are set forth and described in the Figures. It will be appreciated that methods and systems in accordance with other example embodiments of the invention can include additional procedures or features different than those shown in Figures. Example embodiments are described herein with respect to biological cells. However, it will be understood that these examples are for the purpose of illustrating the principals of the invention, and that the invention is not so limited.

Additionally, methods and systems in accordance with several example embodiments of the invention may not include all of the features shown in these Figures. Throughout the Figures, like reference numbers refer to similar or identical components or procedures.

Unless the context requires otherwise, throughout the specification and claims which follow, the word “comprise” and variations thereof, such as, “comprises” and “comprising” are to be construed in an open, inclusive sense that is as “including, but not limited to.”Reference throughout this specification to “one example” or “an example embodiment,” “one embodiment,” “an embodiment” or various combinations or variations of these terms means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

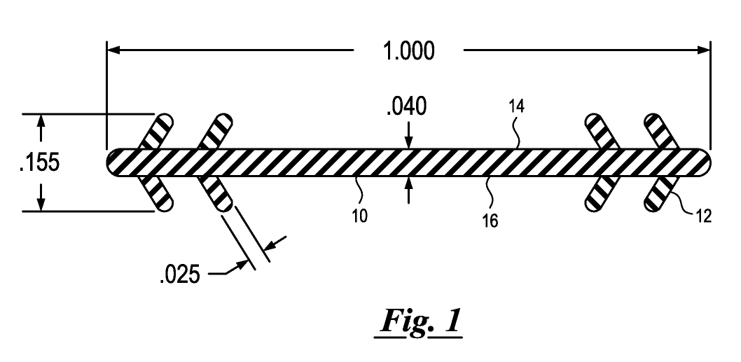

Referring now to FIG. 1, an example of a spline sealing connector is schematically shown. A spline 10 for connecting at least two door frame members together includes a top surface 14 and an opposing bottom surface 16. A plurality of teeth 12 are attached to, integral with or embedded into the top surface 14 as well as the bottom surface 16.

In one example embodiment, the spline 10 is a generally rectangular-shaped, uniformly solid polymeric material having an elongated shape and a width and height that are perpendicular to a direction of elongation of the spline. The width is selected to be sufficient to fit into and extend outside of a groove in a side edge of a first door frame member and fit into a respective groove in a side edge of a second door frame member. For sealing and joining two members, the spline 10 may advantageously have a length matching the length of the first door frame member and the second door frame member so as to form a moisture-resistant seal along the length of the joint. While not considered limiting, in one example the spline has a thickness of at least about 0.040 inches between the top and bottom surfaces, a width of about 1 inch and a plurality of inwardly inclined teeth 12 having a thickness of about 0.025 inches. The plurality of teeth may comprise at least two opposing pairs of inwardly inclined teeth 12, each running the length of the spline.

In a useful example, the spline 10 may have a length of at least 25.5 inches up to the length of any sized door frame member. The spline 10 may be constructed using any known extrusion process or the like. The spline 10 may be constructed from extruded polymeric material, extruded thermoplastic material, co-extruded plastic materials and equivalents. For example, the spline may be constructed from an extruded or co-extruded material made from polymeric materials selected from the group consisting of plastic, polyvinyl chloride (PVC), PVC alloys, polyethylene, polystyrene, thermoplastic elastomer, thermoplastic rubber, polyurethane, acrylic compounds and equivalents.

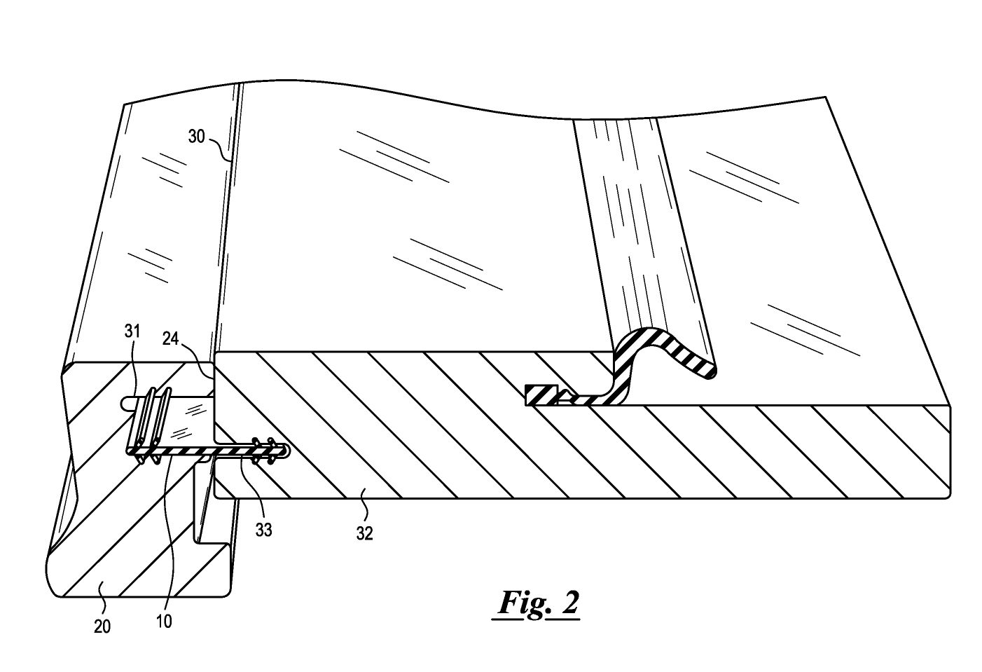

Referring now to FIG. 2, a cross section of an edge view of two door frame members joined by a spline including a reveal surface is shown. At least two door frame members including a brickmould 20 and a jamb 32 are shown in partial cross section joined by a spline 10. The spline 10 has a first side inserted into a brickmould groove 31 and a second side inserted into a jamb groove 33. The brickmould groove 31 and the jamb groove 33 are located so as to allow the formation of a reveal surface 30 (typically called a “reveal”) on the front of a door frame when the door frame members are assembled. Assembly of the door frame is described in more detail below.

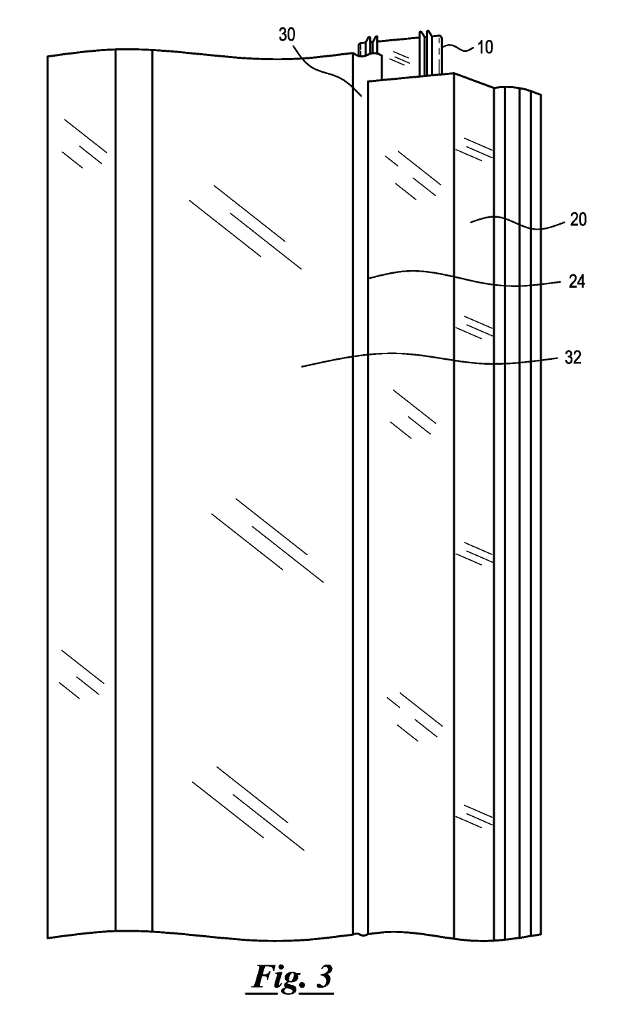

Referring now to FIG. 3, a partially cut away plan view of an example of two door frame members joined by a spline including a reveal surface is shown. The spline 10 is shown protruding in this cut-away view for illustrative purposes. The brickmould 20 and jamb 32 are connected by the spline 10 at joint 24. To form a seal the spline 10 runs the length of joint where the brickmould 20 and the jamb member 32 are substantially equal lengths.

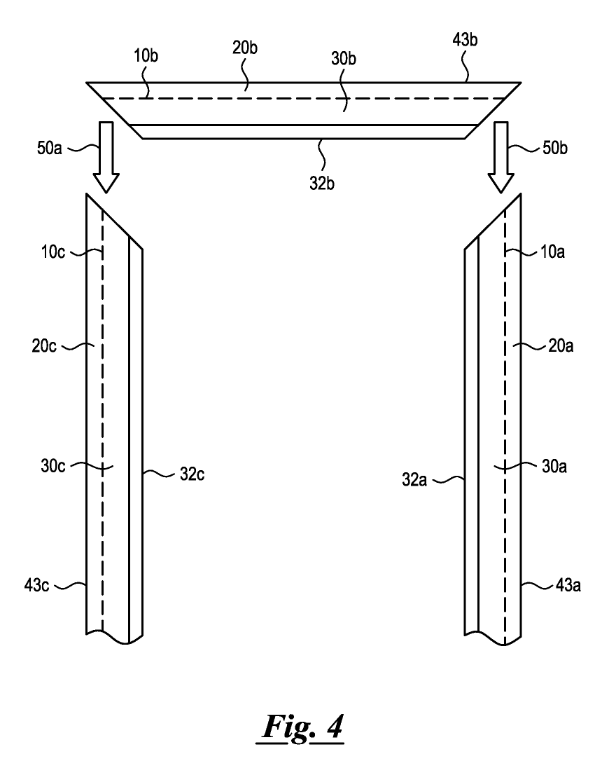

Referring now to FIG. 4, an exploded view of an example of a door system wherein a plurality of door frame members are assembled to provide a door frame having a uniform reveal is shown. Right, left and top jamb members 32a, 32b and 32c respectively, are each joined to right, left and top brickmould members 20a, 20b and 20c respectively by a plurality of splines 10a, 10b and 10c to form door frame sections 43a, 43b and 43c. The door frame sections 43a, 43b and 43c are then assembled together using conventional techniques to form a door frame as generally indicated by directional arrows 50A, 50B. When the door frame sections 43a, 43b and 43c are assembled, the plurality of splines 10a, 10b and 10c are concealed from view.

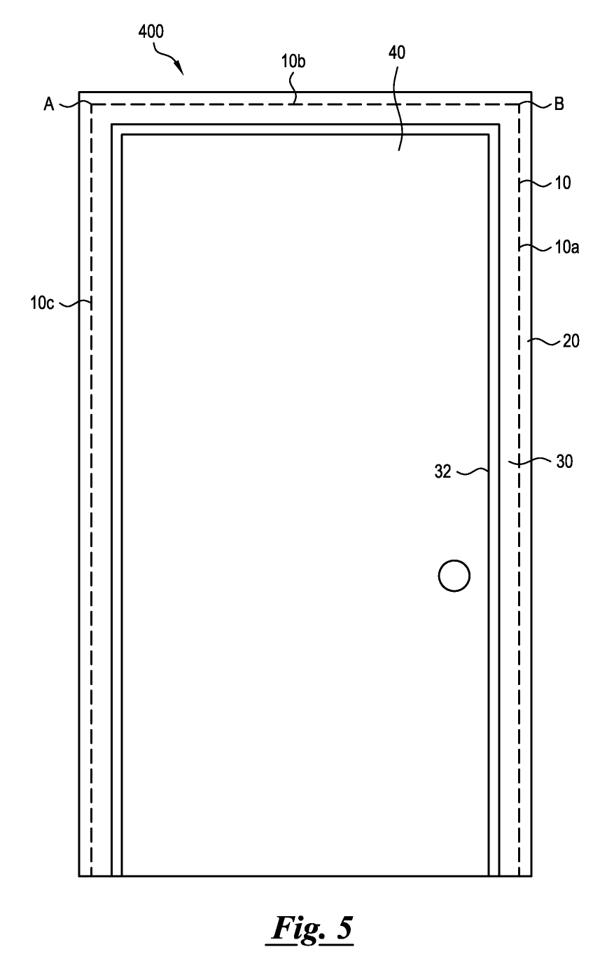

Referring now to FIG. 5, a front view of an example of a door system including a reveal surface is shown. A door system 400 includes a brickmould 20, a jamb 32, a reveal 30 and a door 40. The brickmould 20 and jamb 32 are joined by at least one spline 10. In some embodiments the spline connector may comprise a plurality of tightly abutting spline members joined, for example at the corners A, B.

Referring again to the Figures, having described the spline connector and door assembly, it is considered beneficial to the understanding of the disclosure to now describe a method for constructing joints using a uniformly solid polymeric spline to connect at least two door frame members, such as, for example, a brickmould member 20a and a jamb member 32a. In one example, a brickmould member 20a is prepared for joining by cutting a groove 31 into and along a brickmould mating edge. Similarly, a jamb member 32a is prepared for joining by cutting a groove 33 into and along a jamb mating edge. In one useful embodiment the grooves are made by using a circular saw, router or other conventional cutting means. The groove width is selected for a tight snug fit of the spline while still allowing insertion of the spline into the groove. In one example the groove is at least about 0.050 inches.

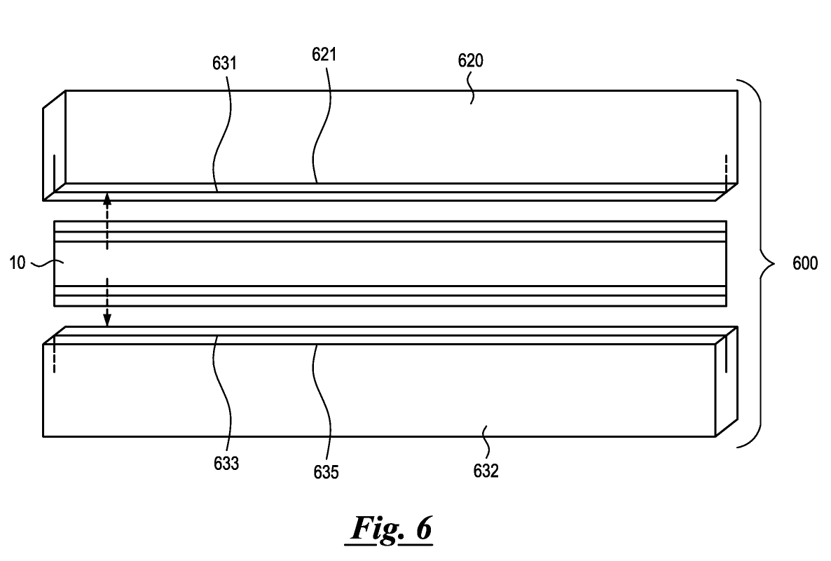

Referring now to FIG. 6, an illustrative example of a method to connect at least two door frame members together is schematically shown. The method includes inserting one edge of at least one elongated spline 10 into a groove 631 in a side edge 621 of a first door frame member 620. The opposite edge of the at least one elongated spline 10 is inserted into a groove 633 in a side edge of a second door frame member 632. The at least one elongated spline 10 includes a polymeric material having a shape and dimensions such that the at least one elongated spline has a sufficient width to fit into and extend outside of the groove in the side edge of the first door frame member and to fit into the groove in the side edge 635 of the second door frame member 632, wherein the at least one elongated spline 10 includes a top surface and a bottom surface. The first door frame member 620 and the second door frame member 632 are forced together so as to connect the first and second door frame members with the spline 10, thereby forming a moisture resistant joint between the first door frame member 620 and the second door frame member 632. After assembly, the spline 10 is concealed from view in an assembled door frame section 600. In one useful embodiment the first door frame member 620 is a brickmould and the second door frame member 632 is a door jamb.

The spline may advantageously be inserted into one of the brickmould groove or the jamb groove by applying a force as by hammering, pressing or other means. A flat surface element, such as a board or flat plate, may be used to buffer and protect the spline from the hammer or press. As described above, the spline is constructed with a plurality of teeth 12 on both the top and bottom surfaces, wherein the plurality of teeth 12 is adapted to the fit into the grooves. In order to allow for a uniform reveal, the grooves are positioned to provide an offset between the brickmould 20 and the jamb 32 when connected by the spline. The spline is inserted into the first groove and the second groove so as to offset the abutting surfaces of the brickmould and the jamb to form a uniform reveal edge on a front side of the joint. In some useful embodiments, the brickmould and the jamb may be constructed from material selected from the group consisting of fiberglass, wood, and wood composites.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A spline for connecting at least two door frame members together, the spline comprising a uniformly solid polymeric material having an elongated shape and a width and height that are perpendicular to a direction of elongation of the spline, wherein the width is sufficient to fit into and extend outside of a first groove in a side edge of a first door frame member and fit into a second groove in a side edge of a second door frame member, wherein the spline includes a top surface and a bottom surface, and wherein the spline has length matching the length of the first door frame member and the second door frame member so as to form a moisture-resistant seal along the length of the joint.

2. The spline of claim 1, wherein the spline is concealed from view when the first door frame member and the second door frame member are connected together by the spline.

3. The spline of claim 1, wherein the spline is rectangular-shaped.

4. The spline of claim 1, wherein the spline has teeth on both the top and bottom surfaces, wherein the teeth are adapted to the fit into the first and second grooves.

5. The spline of claim 1, wherein the spline comprises an extruded polymeric material.

6. The spline of claim 1, wherein the spline comprises an extruded thermoplastic material.

7. The spline of claim 1, wherein the spline comprises a co-extruded material.

8. The spline of claim 1, wherein the spline comprises a co-extruded material made from polymeric materials selected from the group consisting of plastic, polyvinyl chloride (PVC), PVC alloys, polyethylene, polystyrene, thermoplastic elastomer, thermoplastic rubber, polyurethane, and acrylic compounds.

9. The spline of claim 1, wherein the first groove and the second groove are positioned so as to offset the abutting surfaces of the first door frame member and the second door frame member when joined to form a uniform reveal edge along a side of the joint.

10. The spline of claim 1, wherein the first door frame member and the second door frame member comprise material selected from the group consisting of fiberglass, wood, and wood composites.

11. A door frame system comprising a plurality of door frame sections, each door frame section further including a first door frame member and a second door frame member, and at least one spline that is elongated in a direction of elongation, wherein each door frame member has a groove on at least one side thereof, and the spline comprises a polymeric material having a shape such that the spline has a sufficient width to fit into and extend outside of a first groove in the side edge of the first door frame member and to fit into a second groove in a side edge of the second door frame member, wherein the spline includes a top surface and a bottom surface, and wherein the spline has length matching the length of the first door frame member and the second door frame member so as to form a moisture-resistant seal along the length of the joint.

12. The door frame system of claim 11, wherein the at least one spline is concealed from view when the first door frame member and the second door frame member are joined.

13. The door frame system of claim 11, wherein the at least one spline has teeth on both the top and bottom surfaces, wherein the teeth are adapted to the fit into grooves of the first door frame member and the adjacent second door frame member.

14. The door frame system of claim 11, wherein the first door frame member is a brickmould and the second door frame member is a jamb.

15. The door frame system of claim 11, wherein the first door frame member and the second door frame member are arranged to have the first and second grooves located so as to offset the abutting surfaces of the first door frame member and the second door frame member to form a uniform reveal edge at the joint when the first door frame member and the second door frame member are connected.

16. The door frame system of claim 11, wherein the spline comprises a co-extruded material made from polymeric materials selected from the group consisting of plastic, polyvinyl chloride (PVC), PVC alloys, polyethylene, polystyrene, thermoplastic elastomer, thermoplastic rubber, polyurethane, and acrylic compounds.

17. The door frame system of claim 11, further comprising a door attached to at least one of the frame members.

18. A method to connect at least two door frame members together comprising:
inserting one edge of at least one elongated spline into a first groove in a side edge of a first door frame member;
inserting the opposite edge of the at least one elongated spline into a second groove in a side edge of a second door frame member, the at least one elongated spline comprising a polymeric material having a shape and dimensions such that the at least one elongated spline has a sufficient width to fit into and extend outside of the groove in the side edge of the first door frame member and to fit into the groove in the side edge of the second door frame member, wherein the at least one elongated spline includes a top surface and a bottom surface, and
forcing the first door frame member and the second door frame member together so as to connect the first and second door frame members with the spline, thereby forming a moisture resistant joint between the first door frame member and the second door frame member.

19. The method of claim 18, wherein the spline is concealed from view when the first door frame member and the second door frame member are connected together with the spline.

20. The method of claim 18, wherein the first door frame member is a brickmould and the second door frame member is a jamb.

21. The method of claim 18, wherein the first groove and the second groove are located so as to offset the abutting surfaces of the first door frame member and the second door frame member to form a uniform reveal edge at the external joint when the first door frame member and the second door frame member are connected.

22. The method of claim 18, wherein the spline comprises a co-extruded material made from polymeric materials selected from the group consisting of plastic, polyvinyl chloride (PVC), PVC alloys, polyethylene, polystyrene, thermoplastic elastomer, thermoplastic rubber, polyurethane, and acrylic compounds.

23. The method of method of claim 18, wherein the spline is concealed from view when the first door frame member and the second door frame member are joined.
